(19) United States
(12) Patent Application Publication
(10) Pub. No.: US 2019/0188971 A1
(43) Pub. Date: Jun. 20, 2019

(54) METHOD AND SYSTEM FOR CONTINUED GAMING IN THE COURSE OF THE GAME AFTER FORFEITING INTEREST IN THE GAME

(71) Applicants: Pedro Soares de Meirelles, Belo Horizonte/MG (BR); Igor Tadeu Trafane, Sao Paulo/SP (BR)

(72) Inventors: Pedro Soares de Meirelles, Belo Horizonte/MG (BR); Ernesto De Meirelles Salvo, Belo Horizonte/MG (BR); Guilherme Kalil, Belo Horizonte/MG (BR); Igor Tadeu Trafane, São Paulo/SP (BR)

(21) Appl. No.: 15/846,516

(22) Filed: Dec. 19, 2017

(51) Int. Cl. G07F 17/32; A63F 1/00

(52) U.S. Cl. CPC G07F 17/3293; A63F 1/00; A63F 2001/005; G07F 17/3211; G07F 17/3276; G07F 17/3258

(57) ABSTRACT

A method for playing a community card poker card game includes allowing the participants to either fold or place a first bet. The first bet is resolved based on a final card hand associated with the participant, and the combination of first bets comprises a main pot. After first ones of the community cards are revealed, the participants that folded are allowed to either continue to fold or to place a second bet. The second best is resolved based on a final card hand associated with the participant, and the combination of second bets comprises an auxiliary pot. Thereafter, the remaining community cards are revealed, and the main pot is resolved according to a rank of final card hands for those participants that made the first bet. Thereafter, the auxiliary pot is resolved according to a rank of final card hands for those participants that made the second bet.

### FIELD OF THE DISCLOSURE

This disclosure relates generally to gaming systems and gaming administration, and, more particularly, to a method and system for execution of continued gaming in the course of the game after forfeiting an interest in the game.

### BACKGROUND

In the course of a wagering game, a gaming participant will often make the mathematically correct decisions to forfeit play in the rounds of the game, only to realize later that he/she would have (or could have) won that round. For example, in games of poker with community cards and hole cards, a participant will often make the statistically correct decision to fold a hand without seeing all of the community cards, only to realize that he/she would have (or could have) had a winning hand once all the community cards were shown had he/she not folded. Over the course of the game of poker, a participant may make many decisions to fold. While this is generally considered an acceptable aspect of the wagering game by more experienced (e.g., professional) participants, it is often considered a frustrating aspect for amateur (e.g., recreational) participants. In many cases, it leads the amateur participants to abandon the game, often as a result of losing all of his/her stake either through blinds, antes, impatient play of hands, etc. Further, the winnings are often spread unevenly, with the more experienced participants taking more of the winnings and ending the game faster. This leads to a detriment effect on amateur participation in future games of poker. For those that administer these wagering games, such as casinos, tournament organizers, etc. (commonly referred to as the “house”), the viability of the wagering games is dependent upon the participation of amateur participants. Accordingly, there is a desire to maintain amateur participation by addressing the problems of post-forfeit regret and/or concentrated winnings.

### BRIEF DESCRIPTION OF THE DRAWINGS

FIG. 1 is a plan view showing a community card poker game playing surface depicting the participant layouts with hole cards and the community cards in accordance with the disclosure;

FIG. 2 is a plan view showing the community card poker game playing surface of FIG. 1 and further depicting antes from each participant for an auxiliary pot in accordance with the disclosure;

FIG. 3 is a plan view showing the community card poker game playing surface of FIG. 1 and further depicting the formation of the auxiliary pot from the antes of FIG. 2 in accordance with the disclosure;

FIG. 4 is a plan view showing the community card poker game playing surface of FIG. 1 and further depicting participants optioning to either fold or place bets to resolve a main pot in accordance with the disclosure;

FIG. 5 is a plan view showing the community card poker game playing surface of FIG. 1 and further depicting the formation of the main pot, revelation of some of the community cards and an option to fold, or to place bets to resolve the auxiliary pot in accordance with the disclosure;

FIG. 6 is a plan view showing the community card poker game playing surface of FIG. 1 and further depicting continuation of the poker game to resolve the main pot and reveal additional community cards in accordance with the disclosure;

FIG. 7 is a plan view showing the community card poker game playing surface of FIG. 1 and further depicting resolution of the main pot and revelation of all community cards in accordance with the disclosure;

FIG. 8 is a plan view showing the community card poker game playing surface of FIG. 1 and further depicting continuation of the poker game to resolve the auxiliary pot for those participants that opted to place bets to resolve the auxiliary pot in accordance with the disclosure;

FIG. 9 is a plan view showing the community card poker game playing surface of FIG. 1 and further depicting resolution of the auxiliary pot and revelation of participant's hole cards in accordance with the disclosure;

FIG. 10 is a block diagram of an embodiment of a gaming system in accordance with the disclosure; and

FIG. 11 is a block diagram of the electronic components of the gaming unit of FIG. 10 in accordance with the disclosure.

### DETAILED DESCRIPTION

In the following description, numerous terms are utilized. It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

In general, however, terms such as “gaming,” “gambling,” or the like, refer to activities, games, sessions, rounds, hands, rolls, operations, and other events related to wagering games such as web-based games, casino games, card games, and other games the outcome of which is at least partially based on one or more random events (“chance” or “chances”) and on which wagers may be placed by a participant. The words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. For example, a wager may include money, points, credits, symbols, or other items that may have some value related to a wagering game. Wagers may be placed in wagering games that involve the risk of real-world monetary value for the potential of payouts with real-world monetary value or in wagering games that involve no real-world monetary risks for the participant.

Moreover, as used herein, the term “wager” or “bet” includes any form of wagering value, including money, tokens, other physical means for payment, and online or remote electronic authorization of a wager in any acceptable form to the house. The term “house” or “bank” includes any game host, such as a casino, an online or virtual game host, a tournament host, etc. responsible for operating the game, such as distributing chips, keeping track of wagers, and paying winners at the end of the game. Generally speaking, the house takes a scaled commission fee from each game referred to as a “rake”, such as a percentage of the pot (collective wagers) in each hand, with or without a predetermined maximum amount.

Also included are physical representations of money (e.g., tokens) at a playing surface, such as a physical local gaming table and/or electronic wagering interface, as well as virtual representations of money in the form of electronic authorizations of a transfer of money and digital representations of money (e.g., digital representations of bills or coins, digital representations of tokens, numerical quantities of money, numerical quantities of points, or numerical quantities of credits) at a local or remote electronic gaming device (e.g., physical local gaming table, electronic wagering interface, gaming servers, client computing device, or other computing system).

For the purposes of this description, it will be understood that when an action related to accepting wagers, making payouts, dealing cards, selecting cards, or other actions associated with a participant or a dealer are described, the description includes a participant or a dealer taking the action, the results of the action on a live or virtual table or display, and, if applicable, the reception or detection of such an action in an electronic form wherein participant and dealer choices, selections, or other actions are received at an electronic interface. This further includes the results of a virtual dealer and virtual participants, where the actions described are actually generated by a computer (typically associated with an online game). By way of a further example, if dealing of a card is described herein, the description includes (but is not limited to) the following: the distribution of a card by a dealer from a deck, shuffler, shoe, or other card source and the reception or placement of the card at a table location associated with a participant or reception directly by a participant; the generation and transmission of an electronic indication (e.g., an “indicia”) or representation of a card from a game play source or server to an electronic receiver, wherein the receiver may be at a table (using virtual cards) including participants and/or virtual participants and/or a dealer or virtual dealer, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a participant, or, associated with a virtual participant.

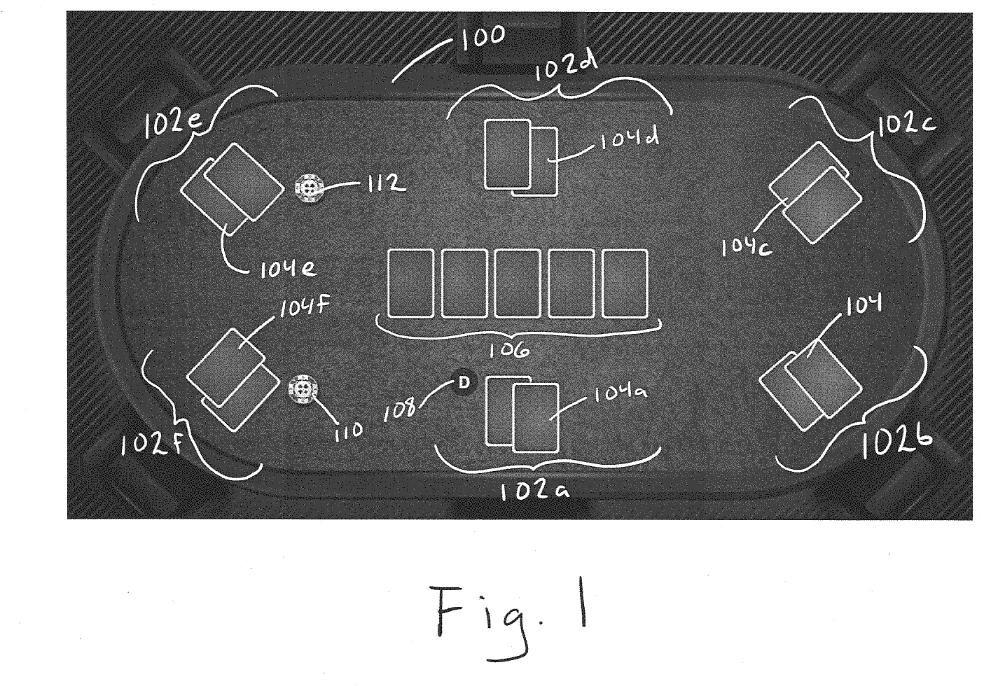

FIGS. 1-9 generally refer to an exemplary sequential method for a poker card game in which a participant has the option to place a bet during a hand of poker after previously folding during the hand (the “unfold” option). The particular poker game used to describe the method in this example is Texas Hold'em, though the described method is equally applicable to any community card poker games, as will be understood by those of ordinary skill in the art. Community card poker games refers to any game of poker that uses community cards (also called “shared cards” or “window cards”), which are cards dealt face up in the center of the table and shared by all participants, and hole cards which are cards that form an incomplete hand and are dealt privately to each participant. The hole cards may be combined with the community cards to form a complete hand. The rules for each particular community poker card game determine how the hole cards may be combined with the community cards, and how different combination of cards rank in terms of resolving the winner of a particular hand. Examples of further community card games include, but are not limited to, Pot Limit Omaha, Pot Limit Omaha Eight or Better, Pineapple, Crazy Pineapple, Courchevel, Five Card Omaha, and Six Card Omaha. In a version of a community card game commonly referred to as Ultimate Texas Hold'em, participants play individually against the house, as opposed to other participants, and, generally speaking, the play, ante and blind bets are grades, depending on who wins, and whether the dealer (house) will open, and payouts according to the participant's hand are made according to a predetermined pay table.

In FIGS. 1-9, the method may include the act of providing one or more decks of physical playing cards (not shown) on a physical playing surface 100, such as a local gaming table, for playing the community card poker game with the unfold option. The physical playing surface 100 may include designated participant areas 102a-102f which correspond to areas in which individual participants of the community card poker game hold their stake of money or physical representations of money (e.g., casino chips) as well as hole cards 104a-104f distributed (e.g., dealt) to each participant from the physical deck of playing cards. Additionally, the physical playing surface 100 may include a designated area for community cards 106, which are distributed from the physical deck of playing cards. In one example, the hole cards 104a-104f may be individually distributed to each participant in their designated participant area 102a-102f (or generally in the vicinity thereof) in a clockwise or counterclockwise manner around the physical playing surface 100, until each participant has the designated number of hole cards 104a-104f per the rules of the community card poker game being played (e.g., two hole cards per participant for Texas Hold'em). Thereafter, the community cards 106 may be distributed to the designated community card area on the physical playing surface 100 according to the designated number of community cards per the rules of the community card poker game being played (e.g., five community cards for Texas Hold'em). Of course, the manner and sequence of distribution of the hole cards and community cards may be made in any manner, which may be dependent upon the particular rules of the community card poker game.

The physical deck of playing cards may be dealt by a game participant designated as the dealer (shown as possessing a dealer button 108). The dealer button 108 may rotate amongst the participants according to the particular rules of the community card poker game, such as in counterclockwise rotation around the physical playing surface 100. In other embodiments, the community card poker game may have a designated dealer who is not a participant of the community card poker game. During the course of the community card poker game, money and/or monetary representations or non-monetary representations may be placed on the physical playing surface 100 in designated areas to represent individual wagers, antes, blinds and/or pots. For the purpose of this description, the term “chips” will be used to refer the value mechanisms for placing wagers, stakes, blinds, antes, etc., though it should be understood that such value mechanisms may take the form of actual money, monetary representations of value or non-monetary representations of value.

The dealer physically carries out the acts of the method of the community card poker game with the unfold option by distributing the hole and community cards, and manipulating (e.g., revealing) the community cards during game play. Each participant carries out the acts of method of the community card poker game with the unfold option by physically manipulating (e.g., revealing) the hole cards 104a-104f and physically placing chips for bets, blinds, antes, etc.

Alternatively, in FIGS. 1-9, the method may include providing a simulation device for playing the community card poker game with the unfold option. The simulation device, whether electro-mechanical or video, may include a display screen, processor, memory and input interface (e.g., touch screen, keyboard, mouse, touch-pad, etc.) as may be found with a personal computer, smart phone, tablet computer, virtual reality device, other consumer/client computing device, a virtual table (e.g., surface with display screen(s)) for multiple, real participants, etc. The simulation device may display a simulated playing surface 100 with simulated designated participant areas 102a-102f, simulated hole cards 104a-104f, simulated community cards 106 and/or simulated dealer designation 108. The simulated designated participant areas 102a-102f may correspond to actual, real life participants in the community card poker game, each of which may possess a simulation device, where the simulated devices are communicatively coupled to one another either directly or indirectly and locally or remotely, for example via a server and/or the Internet. In another example, one or more, but fewer than all participants in the simulated community card poker game may corresponds to actual, real life participants, with the remaining participants being simulations that carry out respective acts (e.g., betting, etc.) as executed by a computer.

The participants (and their simulation devices) may carry out the acts of the community card poker game through manipulation of representations of the physical aspects of the game (e.g., cards, chips, etc.) on the display, which may simulate those acts as if those acts occurred on a physical playing surface. In an embodiment, the simulated acts may correspond to physical acts, such that a participant and/or dealer physical manipulation of cards, money and/or monetary or non-monetary representations may be reflected in a simulation of the same actions on the simulation devices. For example, in a virtual reality setting, a camera or other sensor may monitor the physical actions of a participant and render corresponding actions in the virtual simulation.

Referring to FIG. 1, the playing surface 100 includes designated participant areas 102a-102f, hole cards 104a-104f, community cards 106 and a dealer designation 108, with the dealer having distributed the hole cards 104a-104f and community cards 106 on the playing surface 100. Throughout the description of FIGS. 1-9, common elements in the figures are referred to with similar terminology unless otherwise noted, and generally with corresponding reference numerals as the elements carry over from figure to figure depicting the sequence of the community card poker game with an unfold option.

Each of the hole cards 104a-104f are distributed in a formation (e.g., two cards apiece) to each of the participants in a manner viewable only by the participant to whom the cards were distributed. For example, the hole cards 104a-104f may be distributed to each participant face down on the playing surface 100 within each corresponding designated participant area 102a-102f, such that only the participant may view his/her own hole cards 104a, but not the hole cards 104b-104f of other participants until such time as the participants reveal their cards to the entire playing surface 100. The community cards 106 may be distributed in a linear formation (e.g., five cards in a row), or other designated pattern, face down on the playing surface 100 such that they are not viewable by any participant (or the dealer) until revealed to the entire playing surface 100.

In an embodiment, participants may be required to post blinds 110, 112, such as two blinds to the left of the designated dealer, which may then rotate around the playing surface 100. Typically, such blinds include a small blind 110, as well as a big blind 112 that is twice the value of the small blind, though the value of the blinds 110, 112 may vary according to the rules of the particular community card poker game (e.g., as set by the bank, dealer or participants). The blinds 110, 112 may be used to fund or “seed” the main pot for the game using the participants' chips. In other embodiments, no blinds need to be posted at all. In a similar or alternative embodiment, each participant may be required to post an ante, which may be used to seed the main pot for the game.

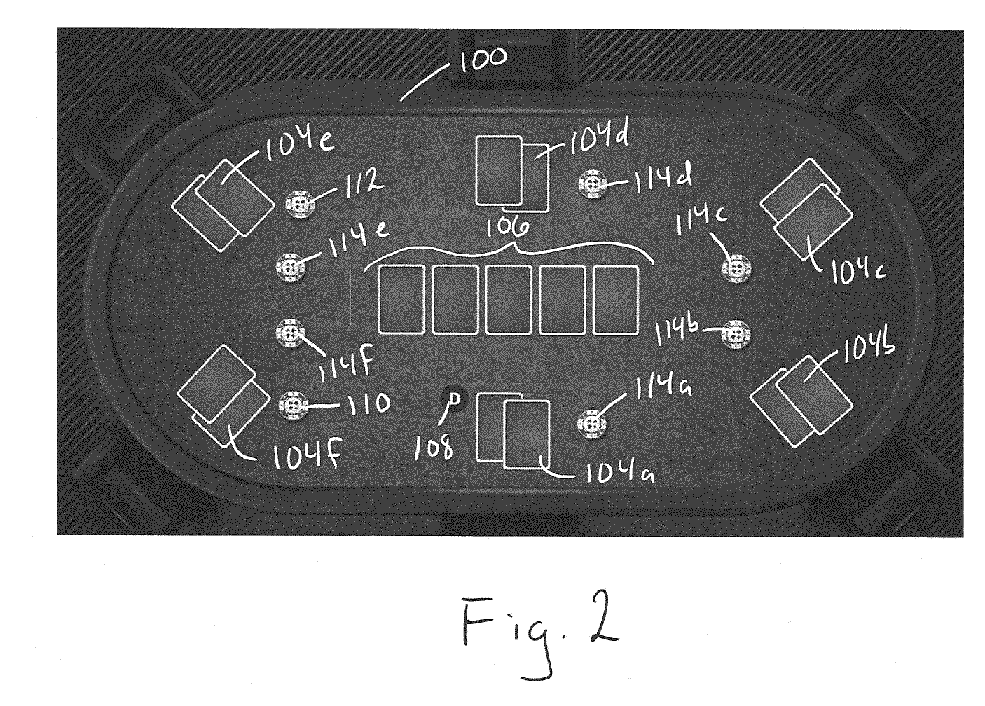

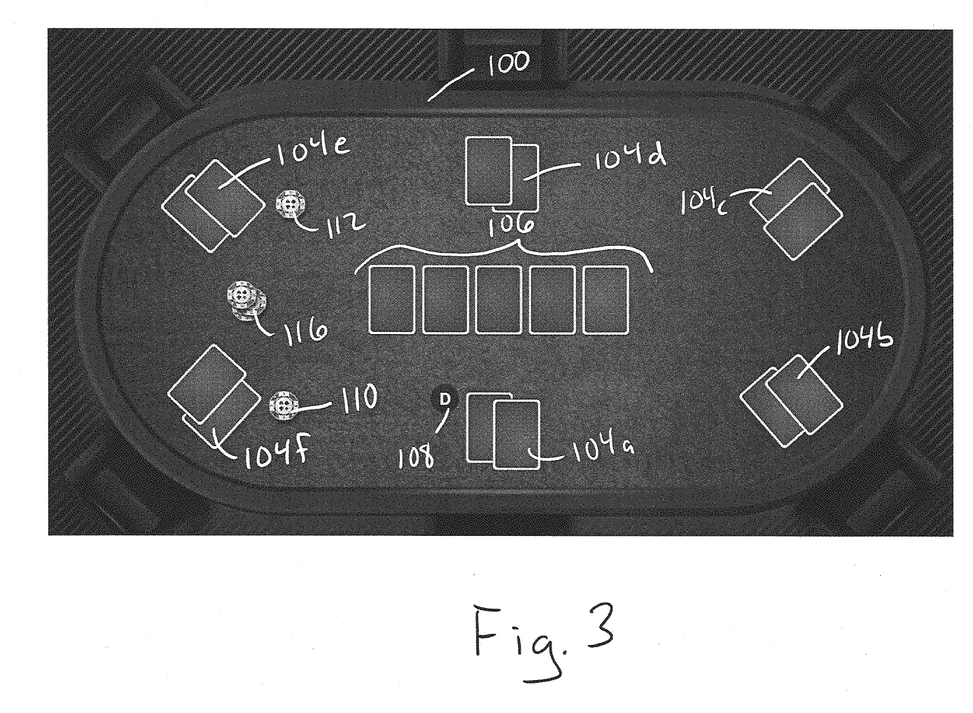

Referring to FIGS. 2 and 3, some or all participants may be required to post unfold blinds or antes 114a-114f in addition to, or as an alternative to, the blinds 110, 112 for the main pot. The unfold blinds may be posted by one or two participants, which may be the same or different participants than those that post the small blind 110 and big blind 112, whereas unfold antes 114a-114f may be posted by each participant. The unfold blinds 114a-114f may be used to seed an auxiliary side pot 116 using the participants' chips. As an example, the value of the unfold blind 114a-114f is equivalent to the value of the small blind 110, though the value of the unfold blinds 114a-114f may vary according to the rules of the particular community card poker game (e.g., as set by the bank, dealer or participants).

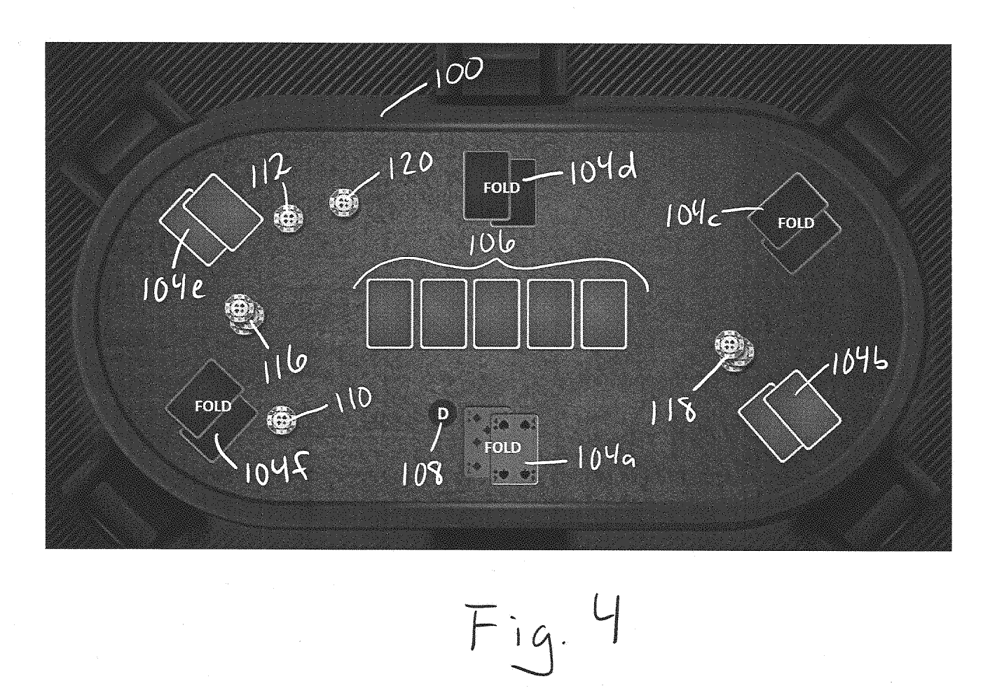

Referring to FIG. 4, once the hole cards 104a-104b and community cards 106 are distributed, and, optionally, the blinds and/or antes posted, the participants begin making bets for the main pot 122. In particular, each participant selects whether to fold, check or place a bet before the community cards 106 are shown. For example, in Texas Hold'em each participant selects either the option to fold (e.g., forfeit the hand) or place a bet based solely on his/her hole cards 104a-104f and without any of the community cards 106 being revealed. As shown, the first, third, fourth and sixth participant have each optioned to fold, whereas the second and fifth participants have each optioned to place a bet. In particular, the second participant has optioned to make an initial wager 118, and the fifth participant has optioned to “call” the second participant's wager by placing wager 120 equivalent to the wager 118 of the second participant. Given that the fifth participant posted the big blind 112, the wager 120 is combined with the blind 112 to amount to the equivalent value to of the second participant's wager 118. It should be understood, however, that participants may make multiple alternating wagers in a round of betting. As such, it is possible that a participant may make a wager only to subsequently fold in the face of additional wagers from other participants. The wagers for the main pot 122 are resolved based on a final card hand of each participant still in the game that optioned to place a wager instead of folding, with the combination of bets going to the main pot 122. It is noted that the hole cards 104a of the first participant are shown for illustrative purposes only, and do not signify that the hole cards 104a are revealed to the rest of the playing surface.

At this juncture, the hole cards 104a-104f and community cards 106 remain unrevealed to the table. In the event that each participant has posted an ante 114a-114f for the auxiliary pot 116, but each of the participants options to fold before any of the community cards 106 are revealed, there exist a few embodiments to resolve the auxiliary pot 116. In an embodiment, in the event all participants fold before any of the community cards 106 are revealed, the antes 114a-114f may be returned to each of the participants.

In another embodiment the participants may reveal their hole cards 114a-114f to the playing surface 100 in order to resolve who receives the auxiliary pot 116 without revealing any of the community cards 106. That is, the auxiliary pot is resolved based solely on the strength of hole cards 114a-114f making up each participant's hand without combining the hole cards 114a-114f with any of the community cards 106 to make a hand, with the auxiliary pot going to the participant with the highest ranking pair of hole cards according to the particular rules of the community card poker game. For example, if the first, third, fourth, fifth and sixth participants have hole cards 104a, 104c-104f of different ranks, whereas the second participant has a pair of nines as his/her hole cards 104b, the auxiliary pot 116 would be resolved in the second participant's favor. In yet another embodiment in the event all participants fold before any of the community cards 106 are revealed, the auxiliary pot 116 may be carried over to the next hand, such that the auxiliary pot 116 is combined with the auxiliary pot of the subsequent hand(s) until such time as the auxiliary pot is resolved according to the rules of the community card poker game. In the event all participants but one option to fold, the remaining participant may be declared the winner of that hand for the purpose of resolving the auxiliary pot 116.

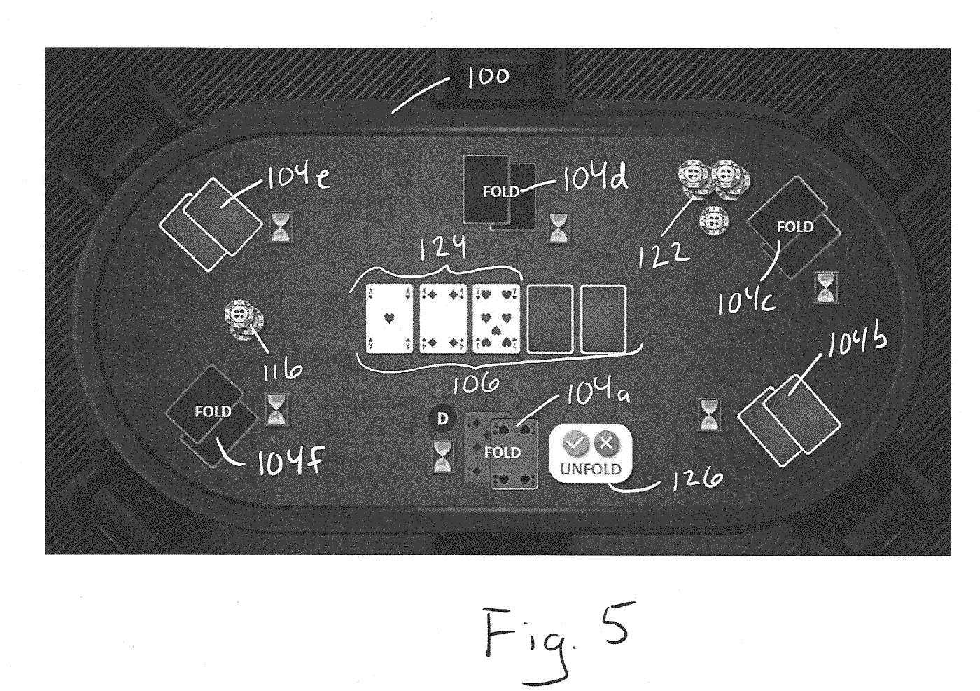

Referring to FIG. 5, once each of the participants has decided to fold, check or place a bet, one or more of the community cards 124 are revealed to the playing surface 100 per the particular rules of the community card poker game being played. In Texas Hold'em, the first three of five community cards are revealed (e.g., turned over by the bank or dealer to be face-up, or otherwise shown face-up in a simulation), which is commonly referred to as the “flop”. However, it should be understood that in other community card poker games, such as Courchevel, community cards 106 may be revealed one or more at a time, with rounds of betting between each revealed card, each time giving the participants the option to fold or to place a bet. In other community card poker games, such as Pineapple, participants may be given additional hole cards 104a-104f at the beginning of the game, and have the option to discard one or more of their hole cards before any of the community cards 106 are revealed, and in yet other community card poker game, such as Crazy Pineapple, participants may have the option to discard one or more of their hole cards after the flop.

At this juncture, each of the participants (including both those that remain in the hand and those that have folded) has the option to decide whether to “unfold” 126 upon revelation of the flop 124. In an embodiment, this option may coincide with a particular window of time (e.g., 5 seconds) in which to make the option so as to maintain the flow of the game. Failure to make a selection may default to not unfold. In another embodiment, only those participants that have folded may be given the option to unfold or not. In either case, the option to unfold allows the participant to make a bet for the auxiliary pot 116 later in the game. These wagers are resolved based on a final card hand of each participant that optioned to unfold, with the combination of such bets going to the auxiliary pot 116. On the other hand, if the participant options not to unfold (e.g., maintain the previous option to fold), that participant does not play for the auxiliary pot 116.

As noted above, the decision to unfold or not is made after one or more, but less than all, of the community cards 106 are revealed. In the case of Texas Hold'em, this may occur after the flop 124. However, the decision to unfold or not may be made at other times, depending on the particular community card poker game being played. For example, in Courchevel, rounds of betting may occur between individual revelation of the first three cards, which together comprise the flop. However, only when the bets of the two other cards of the flop are opened may the participants be given the opportunity to opt in or opt out to unfold their hands. In Pineapple poker, participants discard one of their cards before the flop, and only after the flop is opened are they given the option to unfold or not. In Crazy Pineapple poker, participants may discard one of their cards after the flop, and the decision to unfold or not may be made before or after discarding the card, which may be determined based on rules of the house.

Although the option to unfold or not is shown with respect to the first participant, this is for illustrative purposes only. Generally, the selection to unfold or not is known only to each individual participant, as revelation of such a selection to the table may affect decisions in playing for the main pot 122, as it is generally intended that the auxiliary pot 116 be decided independently of the main pot 122, and vice versa. As such, in a community card poker game with physical playing cards on a physical playing surface 100, each participant may be provided with a physical token or other indicia to indicate his/her selection to unfold or not, such as a card or token to place on the physical playing surface 100 with the indicated selection face down. In a simulation environment, the selection may be presented to the participant on his/her display as an indicia independent of the displays of other participants, with the selection being stored on a server administering the game.

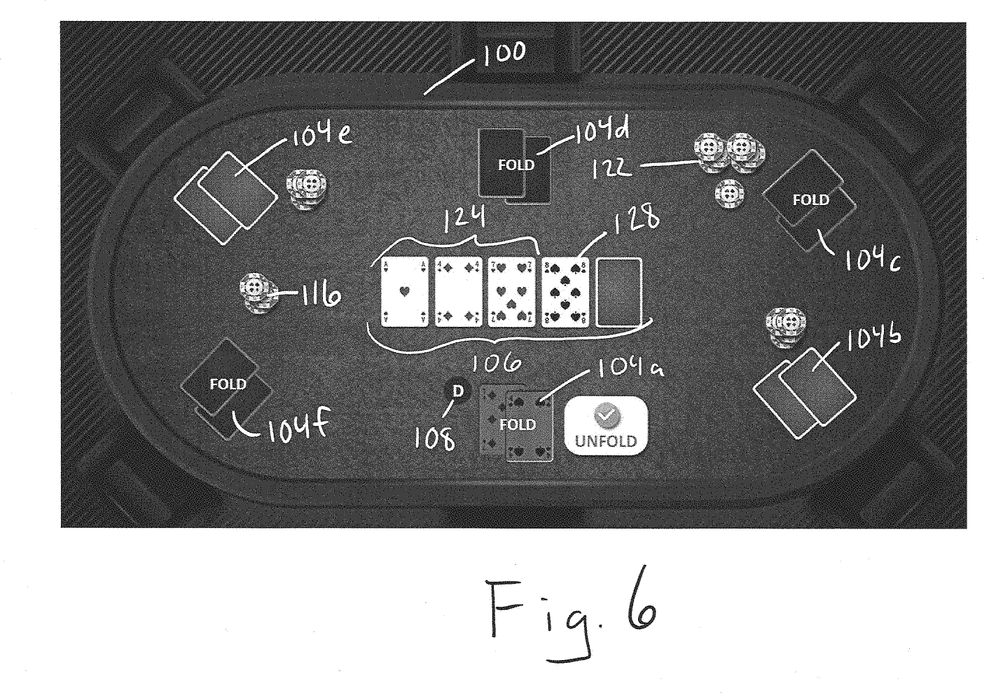

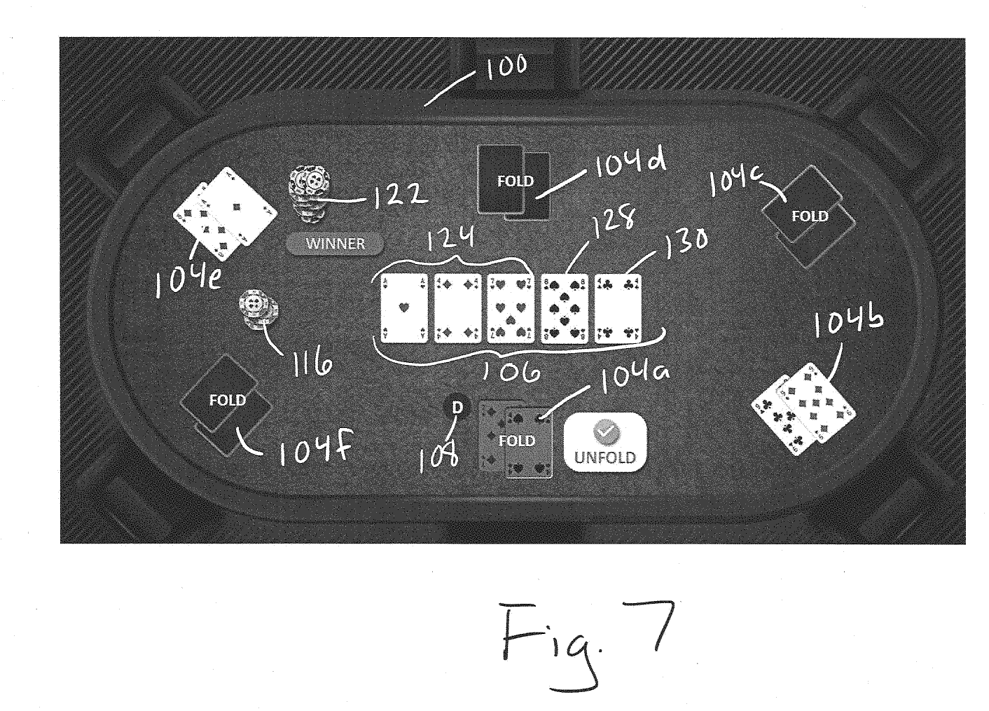

Referring to FIGS. 6 and 7, once the selections to unfold or not have been made, the remaining ones of the community cards 116 may be revealed. In Texas Hold'em, the last two cards are revealed individually, with the fourth card commonly referred to as the “turn” and the fifth card commonly referred to as the “river”. Between each card revelation, additional rounds of betting may occur among those participants that have, thus far, optioned to place a bet and remain in the game, with the main pot 122 accumulating these additional bets. As shown in FIG. 7, once all community cards 116 have been revealed, the participants still in the game reveal their hole cards 104b, 104e to the table 100. In the case of physical playing cards on a physical playing surface 100, each participant turns over his/her hole cards 104b, 104e to be face-up on the table 100. In a simulation environment, the face of the hole cards 104b, 104e may be automatically revealed on each participant's display.

The winning hand is determined based on a ranking of the final card hand of each participant, with the final card hand being the best combination of the participant's hole cards and the community cards according to the particular rules of the community card poker game. In the case of Texas Hold'em, this would be the best five card hand. In some cases only the community cards form a final hand, in which case the highest denomination card(s) among the hole cards is the winning hand, or the hand is deemed a tie. Typically, hands are ranked from strongest to weakest in the following order: Royal flush (Ace, King, Queen, Jack, Ten, all of the same suit); Straight flush (five cards in a sequence, all in the same suit); Four of a kind (all four cards of the same denomination); Full house (three of a kind with a pair); Flush (five cards all of the same suit); Straight (five cards in sequence of any suit); Three of a kind (three cards of the same denomination and two unmatched cards); Two pair (two sets of card of the same denomination and any fifth card); Pair (two cards of the same denomination and three unmatched cards); and No pair (all five cards of different denominations and a variety of suits). Hands that are the same (e.g., two pair) are ranked according to the highest denomination card(s) therein.

Thus, as shown in FIG. 7, the fifth participant is deemed the winner with two pairs of Aces and Eights ranking over the second participant's two pairs of Nines and Eights (Aces ranking over Nines), and the main pot 122 is resolved in the fifth participant's favor (e.g., he/she receives the chips from the main pot 122, though it is understood that in some cases the house make take a predetermined percentage of the pots, commonly referred to as the “rake”). If the additional rounds of betting result in all but one of the remaining participants folding, the main pot 122 is resolved in favor of the remaining participant, at which point all of the community cards 116 may be revealed in order to resolve the auxiliary pot 116.

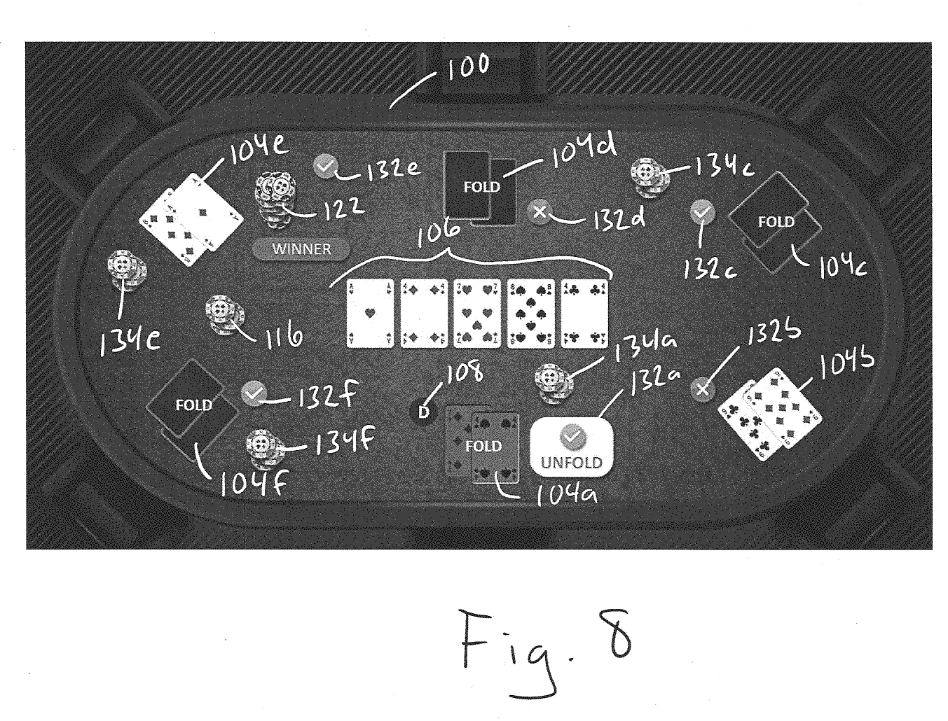

Referring to FIG. 8, once all of the community cards 106 have been revealed, it may further be revealed which participants opted to unfold their hands. In this example, the first third, fifth and sixth participants opted to unfold their hands earlier in the game as described above. As also described above, those participants that opted to bet for the main pot 122 (i.e., the second and fifth participants) were eligible to opt to unfold their hands along with participants that did not opt to bet on the main pot 122 (i.e., the first, third, fourth and sixth participants). However, as also noted above, in another embodiment only those participants that opted to not bet for the main pot 122 may opt to unfold for the auxiliary pot 116 (i.e., only the first, third, fourth and sixth participants). Nonetheless, as shown in FIG. 8, the first third, fifth and sixth participants opted to unfold their hands, which may be revealed to the table by having each participant turn over his/her unfold token 132a-132f on the physical playing surface 100 with the indicated selection facing up. In a simulation environment, the selection may be revealed to all participants on their respective displays by reading the individual selections from a server administering the game.

For those participants that opted to unfold their hands, the participants may post bets 134a, 134c, 134e, 134f per their earlier option to place a bet based on a final card hand to resolve the auxiliary pot. In the embodiment of FIG. 8, the value of the unfold bets are static, in that participants do not bet further wagers beyond the value of the unfold pot 116 or some other set amount. This is because the hole cards of the fifth participant have already been revealed as part of resolving the main pot 122 before, and such a revelation may affect decisions in playing for the auxiliary pot 116. However, in other embodiments, the participants playing for the auxiliary pot may engage in a round of betting to place additional wagers, similar to the final round of betting for the main pot 122 after all the community cards 106 have been revealed. Such embodiments may include the embodiment where only participants that optioned to fold prior to revealing any of the community cards 106 are presented with the option to unfold after the one or more community cards 124 are revealed and select the option to unfold (i.e., the first, third and sixth participants). In such a case, the hole cards 104a, 104c, 104f are not yet revealed at this juncture, thereby allowing these participants to place additional wagers in an additional round of betting, each time being presented with the options of folding or placing a bet. Even in this case, it may be preferable to keep the unfold bets static, in order to keep the value of the auxiliary pot 116 less than the value of the main pot 122, so as to disincentive all participants from opting to fold on the main pot 122 and only play for the auxiliary pot 116 once all of the community cards 106 are revealed. In any event, the bets 134a, 134c, 134e, 134f from the participants combine to form the auxiliary pot 116 along with the unfold antes 114a-114f.

The situation may arise in which an unfold participant had enough of a stake to make the unfold ante and/or unfold blinds 114a-114f and opt to unfold, but in the course of making bets to play for the main pot 122 no longer has enough of a stake to place bets to resolve the auxiliary pot 116 (i.e., a “busted” participant). In such a situation, the auxiliary pot 116 may be split into one pot that is a combination of unfold blinds and/or unfold antes 114a-114f from the participants, and another pot that is a combination of the bets 134a, 134c, 134e, 134f from the unfold participants. The busted participant is thus eligible to win the first pot based on his/her final hand along with the other unfold participants, but is not eligible to win the second pot, whereas the other unfold participants that contributed unfold bets are eligible to win the second pot. In an embodiment, if the busted participant has the best hand among all unfold participants, the busted participant wins the first pot, and the unfold participant with the second best hand wins the second pot.

In another embodiment, a jackpot may be formed from, for example, the unfold antes and/or blinds 114a-114f. In each hand, each unfold participant may play for the auxiliary pot 116 as formed from the unfold bets 134a, 134c, 134e, 134f as described below. The jackpot, on the other hand, may continue to accumulate over the course of many hands, where the unfold antes and/or blinds 114a-114f of each hand contribute to the jackpot. The jackpot may be resolved based on an unfold participant's hand matching a hand on a predetermined pay table. For example, the predetermined pay table may indicate that a percentage of the jackpot goes to an unfold participant that has a Royal Flush, Straight Flush or Four of a kind, where 100% of the jackpot goes to an unfold participant with a Royal Flush, 75% of the jackpot goes to an unfold participant with a Straight Flush, and 50% of the jackpot goes to an unfold participant with Four of a kind. In another example, the jackpot may go to any unfold participant that has a Four of a kind or higher as his/her final hand. In the event more than one unfold participant is eligible to win the jackpot, the jackpot may be split between the unfold participants or the unfold participant with the higher hand wins the entire jackpot. In any event, the jackpot is resolved according to a comparison of final card hands of the unfold participants to a predetermined pay table.

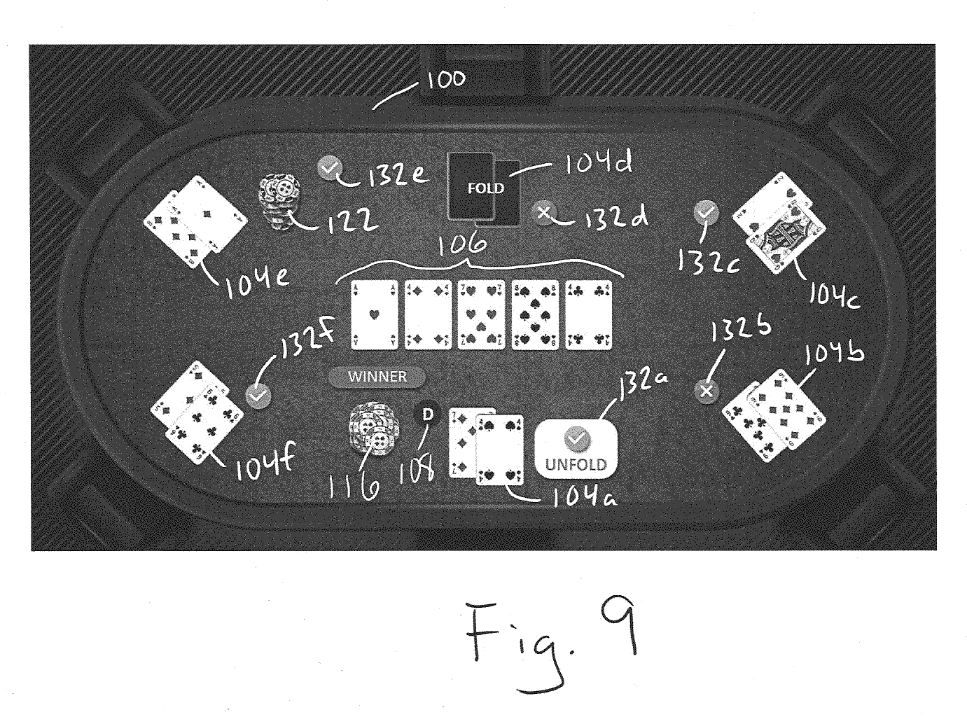

Referring to FIG. 9, the unfold participants reveal their hole cards 104a, 104c, 104f (if they have not already) to the table 100. In the case of physical playing cards on a physical playing surface 100, each unfold participant turns over his/her hole cards 104a, 104c, 104f to be face-up on the table 100. In a simulation environment, the face of the hole cards 104a, 104c, 104f may be automatically revealed on each participant's display.

The winning hand for the auxiliary pot 116 is determined based on a ranking of the final card hand of each participant, with the final card hand being the best combination of the unfold participant's hole cards and the community cards according to the particular rules of the community card poker game. In the case of Texas Hold'em, this would again be the best five card hand, with the hands ranked in order of Royal flush, Straight flush, Four of a kind, Full house, Flush, Straight, Three of a kind, Two pair, Pair and No pair, with hand that are the same being ranked according to the highest denomination card(s), as indicated above. Again, in some cases only the community cards form a final hand, in which case the highest denomination card(s) among the hole cards is the winning hand, or the hand is deemed a tie.

Thus, as shown in FIG. 9, the first participant is deemed the winner of the auxiliary pot 116 with a Full House of Fours over Sevens ranking over the third participant's No Pair, the fifth participant's Two Pair and the sixth participant's Straight. The auxiliary pot 116 is therefore resolved in the first participant's favor (e.g., he/she receives the chips from the auxiliary pot 116), though it is understood that in some cases the house make take a predetermined percentage of the pots (e.g., the “rake”).

Accordingly, participants that opted to fold before any of the community cards 106 were revealed may have the option of continuing to play for an auxiliary pot, particularly if the revelation of first ones of the community cards (e.g., the flop) would have given them a better chance of winning the hand in view of their hole cards. This incentivizes participants that fold to continue playing, and leads to less frustration among the participants, particularly amateur participants, even when it may have been the correct decision to fold before any of the community cards 106 were revealed. Further, the winnings from the community card poker game are better distributed amongst the participants, rather than concentrated with one or a few participants. Still further, this extends play of the community card poker game to include more hands, which is generally desirable among participants. Even further, the house administering the community card poker game may take more of a rake due to the inclusion of the auxiliary pot and extended play, while at the same time maintaining or building a base of amateur participants in order to maintain or increase the viability of the community card poker games, particularly as may be used during tournaments that require a set number of participants in order to be a viable tournament.

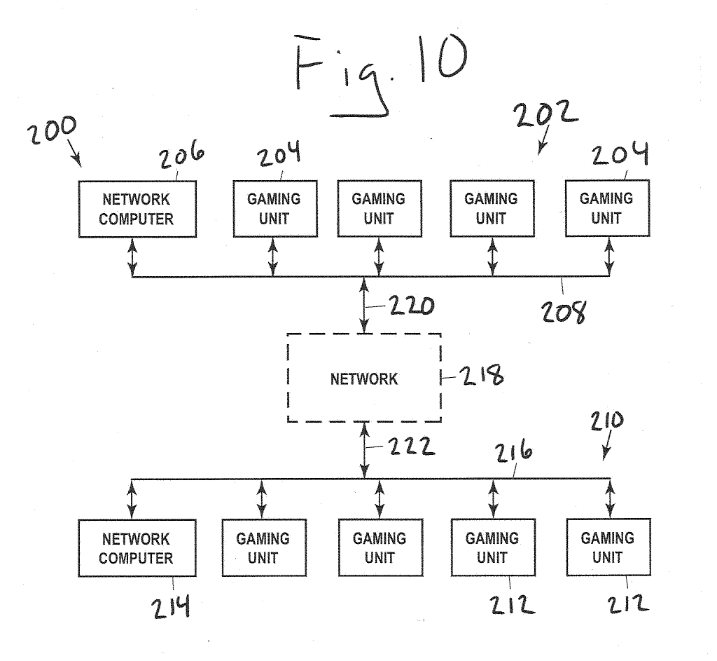

FIG. 10 illustrates one possible embodiment of a poker gaming system 200 in that may execute the above-described community card poker game with unfold option on one or more simulation devices in accordance with the disclosure. Referring to FIG. 10, the poker gaming system 200 may include a first group or network 202 of simulation devices, disclosed herein as poker gaming units 204 operatively coupled to a network computer 206 via a network data link or a bus 208. The poker gaming system 200 may include a second group or network 210 of poker gaming units 212 operatively coupled to a network computer 214 via a network data link or a bus 216. The first and second gaming networks 202, 210 may be operatively coupled to each other via a network 218, which may comprise, for example, the Internet, a wide area network (WAN), or a local area network (LAN) via a first network link 220 and a second network link 222.

The first network 202 of gaming units 204 may be provided in a first location, and the second network 210 of gaming units 212 may be provided in a second separate geographic location than the first location. For example, the two locations may be located in different areas of the same city, located in different states and/or located in different areas of the world. In another embodiment, the gaming units 204, 212 may each be provided in separate geographic locations, such as different areas of the same city, different states, different areas of the world, etc. The network 218 may include a plurality of network computers or server computers (not shown), each of which may be operatively interconnected. Where the network 218 comprises the Internet, data communication may take place over the communication links 220, 222 via an Internet communication protocol.

The network computer 206 may be a server computer and may be used to accumulate and analyze data relating to the operation of the gaming units 204. For example, the network computer 206 may continuously receive data from each of the gaming units 204 indicative of the dollar amount and number of wagers being made on each of the gaming units 204, data indicative of how much each participant is receiving in winnings, data regarding the identity and gaming habits of participants playing each of the gaming units 204, etc. The network computer 214 may be a server computer and may be used to perform the same or different functions in relation to the gaming units 212 as the network computer 214 described above.

Although each network 202, 210 is shown to include one network computer 206, 214 and four gaming units 204, 212, it should be understood that different numbers of computers and gaming units may be utilized. For example, the network 202 may include a plurality of network computers 206 and tens or hundreds of gaming units 204, all of which may be interconnected via the data link 208. The data link 208 may be provided as a dedicated hardwired link, a wireless link, a fiber optic link, or a network (LAN, WAN, Internet, Intranet) connection. Although the data link 208 is shown as a single data link 208, the data link 208 may comprise multiple data links.

As a further alternative, the operation of the gaming units may be monitored and/or coordinated without the use of a central computer or controller. A system is envisioned wherein the gaming units are coupled together using data links, which data links may be hardwired links, wireless links, fiber optic links or network connections, rather than to a central computer or controller. During operation, the processing required by the operations otherwise performed by a network computer or controller may be shared among the gaming units. Such shared processing may be referred to as peer-to-peer networking, and is within the scope of the present disclosure.

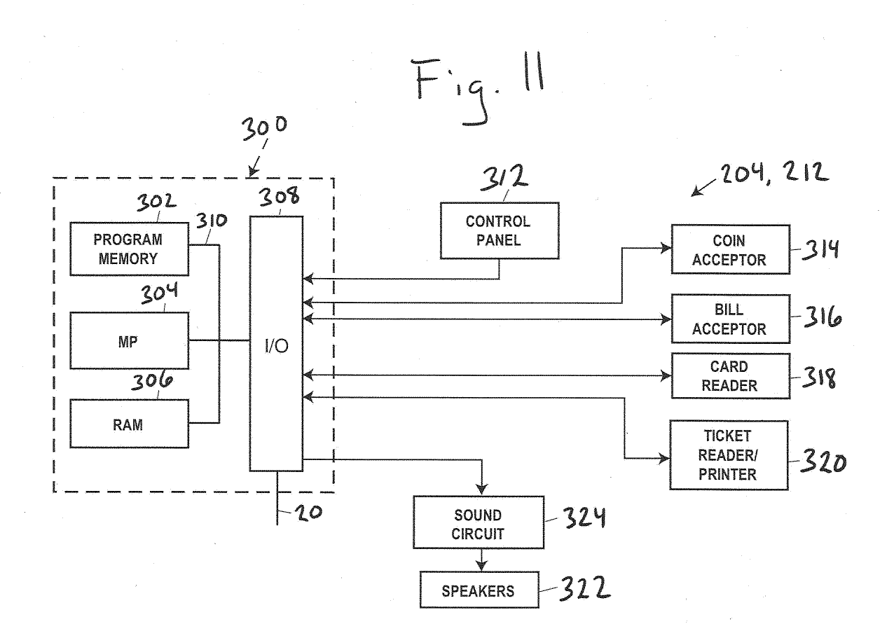

FIG. 11 is a block diagram of a number of components that may be incorporated in the gaming unit 204, 212. Referring to FIG. 11, the gaming unit 204, 212 may include a controller 300 that may comprise a program memory 302, a microcontroller or microprocessor (MP) 304, a random-access memory (RAM) 306 and an input/output (I/O) circuit 308, all of which may be interconnected via an address/data bus 310. The gaming unit 204, 212 may further include a control panel or interface 312, which may be a keyboard, touch screen interface, computer mouse, graphical user interface, etc., which is operatively coupled to the controller 300. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 308 is shown as a single block, it should be appreciated that the I/O circuit 308 may include a number of different types of I/O circuits. The RAM(s) 306 and program memories 302 may be implemented as semiconductor memories, magnetically readable memories, and/or optically readable memories, for example.

The program memory 302 may be a read-only memory (ROM), or a read/write or alterable memory, such as a hard disk. In the event a hard disk is used as a program memory 302, the address/data bus 310 shown schematically in FIG. 11 may comprise multiple address/data buses, which may be of different types, and there may be an I/O circuit disposed between the address/data buses.

Furthermore, while the controller 300 is shown as a dashed box surrounding the memories 302, 306, processor 304, and I/O circuit 308, this should not be interpreted as a physical limitation on the controller 300. The memories 302, 306 and processor 304 may be disposed on a single board, or they may be disposed on separate boards. Similarly, the I/O circuit 308 may be disposed on the same board as the memories 302, 306 and processor 304, or they may be disposed on separate boards.

Optionally, where the poker gaming unit 204, 212 may be provided as a casino gaming unit, whether electro-mechanical or video, FIG. 11 illustrates that a coin acceptor 314, a bill acceptor 316, a ticket reader/printer 318 and/or a card reader 320 may be operatively coupled to the I/O circuit 308, each of those components being so coupled by either a unidirectional or bidirectional, single-line or multiple-line data link, which may depend on the design of the component that is used. Speaker(s) 322 may be operatively coupled to a sound circuit 324, that may comprise a voice- and sound-synthesis circuit or that may comprise a driver circuit. The sound-generating circuit 324 may be coupled to the I/O circuit 308.

As shown in FIG. 11, the components 314-324 may be connected to the I/O circuit 308 via a respective direct line or conductor. Different connection schemes could be used. For example, one or more of the components shown in FIG. 11 may be connected to the I/O circuit 308 via a common bus or other data link that is shared by a number of components. Furthermore, some of the components may be directly connected to the microprocessor 304 without passing through the I/O circuit 308.

One manner in which one or more of the gaming units 204 (and one or more of the gaming units 212) may operate is described below in connection with a number of flowcharts which may be implemented as a number of portions or routines of one or more computer programs. These programs or portions of programs may be represented as a set of instructions that may be carried out by the controller 300, for example.

The programs or portions of programs may be written in any high level language such as C, C++, C#, Java, Visual Basic or the like, or any low-level assembly or machine language. The programs or portions of programs may include data files, binary files, scripts, data tables, graphic file formats, 3D models, etc. Furthermore, the programs or portions of programs may be implemented using an event-based triggering system. That is, the controller 300, for example, may generate an event (for example, in connection with a game outcome) that is in turn communicated to a display unit, the sound circuit 324, and a payout device, for example, the ticket reader/printer 320. Each unit or device may then determine if the communicated event has significance for that unit or device, and what that significance may be. As a result, units or device may be added or removed from the gaming unit 204, 212 without requiring significant reprogramming of the controller 300, thereby permitting a modular approach to be implemented.

It will also be recognized that the programs or portions of programs may be stored on a machine accessible medium. A machine accessible medium includes any mechanism that provides (i.e., stores and/or transmits) information in a form accessible by a machine (e.g., a computer, network device, personal digital assistant, any device with a set of one or more processors, etc.). For example, a machine accessible medium includes recordable/non-recordable magnetic, optical and solid-state media (e.g., read only memory (ROM), programmable read only memory (PROM), erasable programmable read only memory (EPROM), electrically erasable programmable read only memory (EEPROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc.

According to the present embodiment, the machine-accessible medium may include the memories 302, 306 of the controller 300. Alternatively, the programs or portions of programs may be stored remotely, outside of the gaming unit 204, 212, and may control the operation of the gaming unit 204, 212 from a remote location. Such remote control may be facilitated with the use of a wireless connection, or by an Internet interface that connects the gaming unit 54 with a remote computer (such as one of the network computers 206, 214) having a memory in which the computer program portions are stored. By storing the programs or portions of programs therein, various portions of the memories are physically and/or structurally configured in accordance with the instructions of the programs or portions of programs.

The previous aspects of the disclosure are exemplary only and not intended to limit the scope of the disclosure. The following additional considerations apply to the foregoing discussion. Throughout this specification, actions described as performed by any device or routine generally refer to actions or processes of a processor manipulating or transforming data according to machine-readable instructions. The machine-readable instructions may be stored on and retrieved from a memory device communicatively coupled to the processor. That is, methods described herein may be embodied by a set of machine-executable instructions stored on a computer readable medium (i.e., on a memory device). The instructions, when executed by one or more processors of a corresponding device (e.g., a server, a user interface device, etc.), cause the processors to execute the method. Where instructions, routines, modules, processes, services, programs, and/or applications are referred to herein as stored or saved on a computer readable memory or on a computer readable medium, the words “stored” and “saved” are intended to exclude transitory signals.

Additionally, throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless specifically stated otherwise, discussions herein using words such as “processing,” “computing,” “calculating,” “determining,” “identifying,” “presenting,” “causing to be presented,” “causing to be displayed,” “displaying,” or the like may refer to actions or processes of a machine (e.g., a computer) that manipulates or transforms data represented as physical (e.g., electronic, magnetic, biological, or optical) quantities within one or more memories (e.g., volatile memory, non-volatile memory, or a combination thereof), registers, or other machine components that receive, store, transmit, or display information.

When implemented in software, any of the applications, services, and engines described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f) and/or pre-AIA 35 U.S.C. § 112, sixth paragraph.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

What is claimed is:

1. A method comprising:
providing at least one deck of physical playing cards;
distributing community cards from the deck of physical playing cards in a formation on a playing surface not viewable by any of a plurality of participants;
distributing one or more hole cards from the deck of physical playing cards to each of a plurality of participants in a formation viewable only to each respective participant;
after distributing the community cards and the hole cards, receiving from each of the participants a first selection of: 1) a fold option, or 2) a first bet option, the first bet designated to be resolved based on a final card hand associated with the participant, the final card hand being a combination of at least one of the participant's hole cards and at least one of the community cards, or the final card hand being a combination of a plurality of the community cards, and the combination of first bets comprising a main pot;
after receiving the first selections, revealing one or more first ones of the community cards to the plurality of participants;
after revealing the one or more first ones of the community cards, receiving from each of the participants that selected the fold option in the first selection, a second selection of: 1) an option to maintain the fold option in first selection, or 2) a second bet option, the second bet designated to be resolved based on a final card hand associated with the participant, the final card hand being a combination of at least one of the participant's hole cards and at least one of the community cards, or the final card hand being a combination of a plurality of the community cards, and wherein the combination of second bets comprising an auxiliary pot;
after receiving the second selections, revealing one or more remaining ones of the community cards;
after revealing one or more remaining ones of the community cards to the plurality of participants, resolving the main pot according to a rank of final card hands for those participants that selected the first bet option; and
after resolving the main pot, resolving the auxiliary pot according to a rank of final card hands for those participants that selected the second bet option.

2. The method of claim 1, further comprising:
receiving an ante from each of the participants, wherein the auxiliary pot comprises the combination of antes.

3. The method of claim 2, further comprising:
receiving a blind from one of the plurality of participants, wherein a value of the ante corresponds to a value of the blind.

4. The method of claim 2, further comprising after receiving the first selections but before revealing one or more first ones of the community cards, resolving the auxiliary pot according to a rank of hole cards hands for those participants that selected the first bet option.

5. The method of claim 2, further comprising after receiving the first selections but before revealing one or more first ones of the community cards, returning the ante to each of the participants.

6. The method of claim 2, further comprising after receiving the first selections but before revealing one or more first ones of the community cards, accumulating the auxiliary pot with a second auxiliary pot formed in a second poker game.

7. The method of claim 1, further comprising:
after resolving the main pot, revealing those participant that selected the second bet option in the second selection.

8. The method of claim 1, wherein revealing one or more remaining ones of the community cards comprises revealing all remaining ones of the community cards to the plurality of participants.

9. The method of claim 1, wherein receiving from each of the participants that selected the fold option in the first selection, a second selection comprises each participant distributing an indicia corresponding to the second selection on the playing surface in a formation not viewable by any of the remaining participants, the method comprising:
after resolving the main pot, revealing the card corresponding to the second selection; and
after revealing the card corresponding to the second selection, resolving the auxiliary pot according to a rank of final card hands for those participants that selected the second bet option.

10. The method of claim 1, wherein receiving the second selection from each of the participants that selected the fold option in the first selection further comprises receiving a second selection from each of the plurality of participants.

11. The method of claim 1, wherein when each of the second selections comprises an option to maintain the fold option in first selection, resolving the auxiliary pot comprises resolving the auxiliary pot according to the rank of final card hands for those participants that selected the first bet option.

12. The method of claim 1, further comprising receiving a portion of the auxiliary pot in each poker game, the combination of portions of the auxiliary pots comprising a jackpot, the method further comprising:
after resolving the main pot, resolving the jackpot according to a comparison of final card hands for those participants that selected the second bet option to a predetermined pay table.

13. The method of claim 1, wherein revealing one or more first ones of the community cards to the plurality of participants comprises revealing a first one of the community cards to the plurality of participants, the method further comprising:
after revealing the first one of the community cards, receiving from each of the participants that selected the first bet option a third selection of: 1) a fold option, or 2) a third bet designated to be resolved based on a final card hand associated with the participant, the final card hand being a combination of at least one of the participant's hole cards and at least one of the community cards, or the final card hand being a combination of a plurality of the community cards, and wherein the combination of first bets and third bets comprising the main pot;
after receiving the third selections, revealing one or more second ones of the community cards to the plurality of participants; and
after revealing the one or more second ones of the community cards, receiving the second selection from each of the participants that selected the fold option in the first selection.

14. The method of claim 1, wherein distributing one or more hole cards comprises distributing three or more hole cards from the deck of physical playing cards to each of a plurality of participants in a formation viewable only to each respective participant, the method further comprising:
after distributing the community cards and the hole cards, receiving from each participant at least one discarded hole card; and
after receiving at least one discarded hole card from each participant, receiving from each of the participants the first selection.

15. The method of claim 1, wherein distributing one or more hole cards comprises distributing three or more hole cards from the deck of physical playing cards to each of a plurality of participants in a formation viewable only to each respective participant, the method further comprising:
after revealing the one or more first ones of the community cards, receiving from each participant at least one discarded hole card.

16. The method of claim 15, further comprising:
after revealing the one or more first ones of the community cards, receiving the second selection from each of the participants that selected the fold option in the first selection; and
after receiving the second selections, receiving at least one discarded hole card from each participant.

17. The method of claim 15, further comprising:
after receiving at least one discarded hole card from each participant, receiving the second selection from each of the participants that selected the fold option in the first selection.

18. A method comprising:
providing a simulation device having a processor, a display screen operatively coupled to the processor, a memory operatively coupled to the processor and an input interface operatively coupled to the processor; and
generating, using the processor, simulations of the following on the display screen of the simulation device:
distributing community cards from a deck of playing cards in a formation on a playing surface not viewable by any of a plurality of participants;
distributing one or more hole cards from the deck of playing cards to each of a plurality of participants in a formation viewable only to each respective participant;
after distributing the community cards and the hole cards, receiving from each of the participants a first selection of: 1) a fold option, or 2) a first bet option, the first bet designated to be resolved based on a final card hand associated with the participant, the final card hand being a combination of at least one of the participant's hole cards and at least one of the community cards, or the final card hand being a combination of a plurality of the community cards, and the combination of first bets comprising a main pot;
after receiving the first selections, revealing one or more first ones of the community cards to the plurality of participants;
after revealing the one or more first ones of the community cards, receiving from each of the participants that selected the fold option in the first selection, a second selection of: 1) an option to maintain the fold option in first selection, or 2) a second bet option, the second bet designated to be resolved based on a final card hand associated with the participant, the final card hand being a combination of at least one of the participant's hole cards and at least one of the community cards, or the final card hand being a combination of a plurality of the community cards, and wherein the combination of second bets comprising an auxiliary pot;
after receiving the second selections, revealing one or more remaining ones of the community cards;
after revealing one or more remaining ones of the community cards to the plurality of participants, resolving the main pot according to a rank of final card hands for those participants that selected the first bet option; and
after resolving the main pot, resolving the auxiliary pot according to a rank of final card hands for those participants that selected the second bet option.

19. The method of claim 18, further comprising generating, using the processor, a simulation of the following on the display screen of the simulation device:
receiving an ante from each of the participants, wherein the auxiliary pot comprises the combination of antes.

20. The method of claim 19, further comprising generating, using the processor, a simulation of the following on the display screen of the simulation device:
receiving a blind from one of the plurality of participants, wherein a value of the ante corresponds to a value of the blind.

21. The method of claim 19, further comprising generating, using the processor, a simulation of the following on the display screen of the simulation device:
after receiving the first selections but before revealing one or more first ones of the community cards, resolving the auxiliary pot according to a rank of hole cards hands for those participants that selected the first bet option.

22. The method of claim 19, further comprising generating, using the processor, a simulation of the following on the display screen of the simulation device:
after receiving the first selections but before revealing one or more first ones of the community cards, returning the ante to each of the participants.

23. The method of claim 19, further comprising generating, using the processor, a simulation of the following on the display screen of the simulation device:
after receiving the first selections but before revealing one or more first ones of the community cards, accumulating the auxiliary pot with a second auxiliary pot formed in a second poker game.

24. The method of claim 18, further comprising generating, using the processor, a simulation of the following on the display screen of the simulation device:
after resolving the main pot, revealing those participant that selected the second bet option in the second selection.

25. The method of claim 18, wherein revealing one or more remaining ones of the community cards comprises revealing all remaining ones of the community cards to the plurality of participants.

26. The method of claim 18, wherein receiving from each of the participants that selected the fold option in the first selection, a second selection comprises each participant distributing an indicia corresponding to the second selection on the playing surface in a formation not viewable by any of the remaining participants, the method comprising generating, using the processor, a simulation of the following on the display screen of the simulation device:
after resolving the main pot, revealing the card corresponding to the second selection; and
after revealing the card corresponding to the second selection, resolving the auxiliary pot according to a rank of final card hands for those participants that selected the second bet option.

27. The method of claim 18, wherein receiving the second selection from each of the participants that selected the fold option in the first selection further comprises receiving a second selection from each of the plurality of participants.

28. The method of claim 18, wherein when each of the second selections comprises an option to maintain the fold option in first selection, resolving the auxiliary pot comprises resolving the auxiliary pot according to the rank of final card hands for those participants that selected the first bet option.

29. The method of claim 18, further comprising generating, using the processor, a simulation of the following on the display screen of the simulation device:
receiving a portion of the auxiliary pot in each poker game, the combination of portions of the auxiliary pots comprising a jackpot, the method further comprising:
after resolving the main pot, resolving the jackpot according to a comparison of final card hands for those participants that selected the second bet option to a predetermined pay table.

30. The method of claim 18, wherein revealing one or more first ones of the community cards to the plurality of participants comprises revealing a first one of the community cards to the plurality of participants, the method further comprising generating, using the processor, a simulation of the following on the display screen of the simulation device:
after revealing the first one of the community cards, receiving from each of the participants that selected the first bet option a third selection of: 1) a fold option, or 2) a third bet designated to be resolved based on a final card hand associated with the participant, the final card hand being a combination of at least one of the participant's hole cards and at least one of the community cards, or the final card hand being a combination of a plurality of the community cards, and wherein the combination of first bets and third bets comprising the main pot;
after receiving the third selections, revealing one or more second ones of the community cards to the plurality of participants; and
after revealing the one or more second ones of the community cards, receiving the second selection from each of the participants that selected the fold option in the first selection.

31. The method of claim 18, wherein distributing one or more hole cards comprises distributing three or more hole cards from the deck of playing cards to each of a plurality of participants in a formation viewable only to each respective participant, the method further comprising generating, using the processor, a simulation of the following on the display screen of the simulation device:
after distributing the community cards and the hole cards, receiving from each participant at least one discarded hole card; and
after receiving at least one discarded hole card from each participant, receiving from each of the participants the first selection.

32. The method of claim 18, wherein distributing one or more hole cards comprises distributing three or more hole cards from the deck of playing cards to each of a plurality of participants in a formation viewable only to each respective participant, the method further comprising generating, using the processor, a simulation of the following on the display screen of the simulation device:
after revealing the one or more first ones of the community cards, receiving from each participant at least one discarded hole card.

33. The method of claim 32, further comprising generating, using the processor, a simulation of the following on the display screen of the simulation device:
after revealing the one or more first ones of the community cards, receiving the second selection from each of the participants that selected the fold option in the first selection; and
after receiving the second selections, receiving at least one discarded hole card from each participant.

34. The method of claim 32, further comprising generating, using the processor, a simulation of the following on the display screen of the simulation device:
after receiving at least one discarded hole card from each participant, receiving the second selection from each of the participants that selected the fold option in the first selection.

35. The method of claim 18, wherein providing a simulation device comprises providing a simulation device to each participant, each simulation device having a processor, a display screen operatively coupled to the processor, a memory operatively coupled to the processor and an input interface operatively coupled to the processor.

36. The method of claim 35, wherein the plurality of simulation devices are communicatively coupled to one another via a network.

37. The method of claim 36, wherein the plurality of simulation devices are communicatively coupled to one another via the Internet.

38. The method of claim 36, wherein the plurality of simulation devices are communicatively coupled to one another via a direct connection.

39. The method of claim 18, wherein providing a simulation device comprises providing a common simulation device to two or more of the participants.
